(19) United States
(12) Patent Application Publication
(10) Pub. No.: US 2015/0020204 A1
(43) Pub. Date: Jan. 15, 2015

(54) METHOD, SYSTEM AND SERVER FOR MONITORING AND PROTECTING A BROWSER FROM MALICIOUS WEBSITES

(71) Applicant: Tencent Technology (Shenzhen) Co., Ltd., Shenzhen (CN)

(72) Inventors: Wanxin Wang, Shenzhen (CN); Dongsheng Niu, Shenzhen (CN)

(21) Appl. No.: 14/500,026

(22) Filed: Sep. 29, 2014

Related U.S. Application Data
(63) Continuation of application No. PCT/CN2014/070455, filed on Jan. 10, 2014.

(30) Foreign Application Priority Data
Jun. 27, 2013 (CN) 2013102615294

(51) Int. Cl. H04L 29/06; G06F 17/30; H04L 29/08

(52) U.S. Cl. CPC H04L 63/1433; H04L 67/02; G06F 17/30873
USPC 726/25

(57) ABSTRACT

A method and apparatus for protecting a browser from malicious web sites have been disclosed. The method including: sending a request for accessing a web page to a server, and receiving the web page sent by the server; analyzing content of the received web page and displaying on the browser subsequent analyzed content of the web page. The displaying of the subsequent content include: generating monitoring data corresponding to monitoring an operation which is initiated and executed by an execution module, and sending the monitoring data to the server for analysis, the server determines whether the browser would be at risk in executing the corresponding operation by the execution module; if so, sending one or more notice to the browser such that the risk would be avoided when the execution module in the browser executes the operation corresponding to the received notice.

### CROSS-REFERENCE TO RELATED APPLICATIONS

The application is a continuation of PCT Application No. PCT/CN2014/070455, filed on Jan. 10, 2014, which claims priority to Chinese Patent Application No. 2013102615294, filed on Jun. 27, 2013, which is incorporated by reference in their entireties.

### FIELD OF TILE TECHNOLOGY

The invention belongs to the field of browser technology; in particular, it involves a method, system and a server for monitoring and protecting a browser from visiting websites which send malicious codes.

### BACKGROUND

The development of mobile terminals technology and Internet technology move at a fast pace. For example, mobile terminals such as personal computers (PCs), digital TVs and the cell phones have become important tools for acquiring information on-line. These mobile terminals are usually equipped with multiple application modules, such as a photographing module, a video recording module, an audio recording module, a geographical location module, a network module, a short message module and an address book module, which implements multiple functions, such as photography, video recording, audio recording, geographical location determination, network connection, short messages receiving and sending and contact viewing information.

People may sometimes browse web pages without knowing that these web pages may contain malicious codes (i.e., viruses, phishing, Trojan horse, worms, etc.) which may take over control of an execution module of the browser in order to subsequently control various other application modules on the mobile terminal to invade user's personal privacy or stealing user's sensitive information stored on the mobile terminal which may incur tremendous economic damages. Some of these applications on the mobile terminal under malicious control may include turning on a video camera, acquiring sent or received short messages which have been saved on the mobile terminal, to name a few.

### SUMMARY

An embodiment of the present disclosure has provided a method for monitoring and protecting a browser from malicious websites, the method include: sending a request for accessing a web page to a server, and receiving the web page sent by the server; analyzing content of the received web page by a browser, and displaying on the browser subsequent analyzed content of the web page, wherein the displaying of the subsequent content of the analyzed content of the web page comprising the browser performing the following: generating monitoring data corresponding to monitoring an operation which is initiated and executed by an execution module, subsequent to an initiation of the execution module; and sending the monitoring data to the server for analysis in order that the server providing a determination based on the monitoring data, whether there would be a risk in executing the corresponding operation by the execution module; if it is determined that the execution module would be at risk, receiving one or more notice sent by the server, such that the risk would be avoided when the execution module executes the operation corresponding to the received notice.

Another embodiment of the disclosure discloses a browser for monitoring and protection from malicious websites. The browser may include: at least a memory which stores instruction codes operable as plurality of modules operating in conjunction with at least a processor, wherein the plurality of modules may include: a web page request module, which sends a request for accessing a web page to a server, and receives the web page sent by the server; an analyzing module, which analyzes content of the received web page according to the request, and displays subsequent analyzed content of the web page on the browser, a monitoring module, which generates monitoring data corresponding to monitoring an operation executed by an execution module, subsequent to an initiation of the execution module; and a sending module, which sends the monitoring data to the server for analysis in order that the server provides a determination based on the monitoring data, that whether the execution module would be at risk in executing the corresponding operation; if it is determined that the execution module would be at risk, a processing module which receives and processes one or more notice sent by the server, such that the risk would be avoided when the execution module executes the operation corresponding to the processed received notice.

In another embodiment, the present disclosure discloses a browser monitoring method, the method may include: receiving a request sent by a browser for accessing a web page; sending the requested web page to the browser, wherein the browser displays the web page content, generates monitoring data as a result of monitoring a corresponding operation executed by an execution module; receiving the monitoring data sent by the browser, and analyzing the monitoring data, determining according to the analyzing of the monitoring data, whether the execution module in the browser would be at risk in executing the corresponding operation; if it is determined that the execution module would be at risk, sending one or more notice to the browser, such that the risk would be avoided by the browser when the execution module executes the operation corresponding to the received notice.

In another embodiment, the present disclosure discloses a server for monitoring and protecting a browser from malicious websites. The server includes at least a processor operating in conjunction with at least a memory which stores instruction codes operable as plurality of modules, wherein the plurality of modules may include: a web page sending module, which receives a request sent by a browser for accessing a web page and sends the requested web page to the browser, wherein the browser displays the web page content, generates monitoring data as a result of monitoring a corresponding operation executed by an execution module; a risk judgment module, which: receives the monitoring data sent by the browser, and analyzes the monitoring data, and determines according to the analyzed monitoring data, whether the execution module in the browser would be at risk in executing the corresponding operation; a notification module, which sends one or more notice to the browser, if it is determined that executing the corresponding operation by the execution module would be at risk, such that the risk would be avoided by the browser when the execution module executes the operation corresponding to the received notice.

Furthermore, the present disclosure has provided a monitoring system, wherein the monitoring system may include a browser communicating to a server through a network. The browser may include at least a first memory which stores instruction codes operable as first plurality of modules operating in conjunction with at least a first processor, wherein the first plurality of modules may include: a web page request module, an analyzer module, a monitoring module, and a sending module. The server may include at least a second processor operating in conjunction with at least a second memory which stores instruction codes operable as second plurality of modules, wherein the second plurality of modules may include: a web page sending module, a risk judgment module, and a notification module; wherein: the web page request module of the browser sends a request for accessing a web page to a server, and receives the web page sent by the server; the web page sending module of the server receives the request sent by the browser for accessing the web page and sends the requested web page to the browser; the analyzing module of the browser analyzes content of the received web page by a browser, and displays subsequent analyzed content of the web page on the browser; the monitoring module of the browser generates monitoring data corresponding to monitoring an operation executed by an execution module, subsequent to an initiation of the execution module; the sending module of the browser sends the monitoring data to the server for analysis; the risk judgment module of the server receives the monitoring data sent by the browser, and analyzes the monitoring data, and determines according to the analyzed monitoring data, whether the execution module in the browser would be at risk in executing the corresponding operation; if it is determined that executing the corresponding operation by the execution module would be at risk: the notification module of the server sends one or more notice to the browser, and the processing module of the browser receives and processes the one or more notice, such that the risk would be avoided when the execution module executes the operation corresponding to the processed received notice.

Yet in another embodiment, the present disclosure provides a non-transitory computer-readable medium having stored thereon, a computer program having at least one code section being executable by a mobile terminal which causes the mobile terminal to perform steps for monitoring and protecting a browser from malicious websites, the steps include: sending a request for accessing a web page to a server, and receiving the web page sent by the server; analyzing content of the received web page by a browser, and displaying on the browser subsequent analyzed content of the web page, wherein the displaying of the subsequent content of the analyzed content of the web page comprising the browser performing the following: generating monitoring data corresponding to monitoring an operation which is initiated and executed by an execution module, subsequent to an initiation of the execution module; and sending the monitoring data to the server for analysis in order that the server providing a determination based on the monitoring data, whether there would be a risk in executing the corresponding operation by the execution module; if it is determined that the execution module would be at risk, receiving one or more notice sent by the server, such that the risk would be avoided when the execution module executes the operation corresponding to the received notice.

### BRIEF DESCRIPTION OF THE DRAWINGS

The accompanying drawings are included to provide a further understanding of the claims and disclosure, are incorporated in, and constitute a part of this specification. The detailed description and illustrated embodiments described serve to explain the principles defined by the claims.

FIG. 1 is an exemplary flowchart illustrating a method for monitoring and protecting a browser from malicious websites, according to an embodiment of the disclosure.

FIG. 2A is an exemplary block structural diagram depicting a mobile terminal's executing module executing functions to control a plurality of application modules, and performing the disclosed method for monitoring and protecting a browser from malicious websites as described in FIG. 1, according to an embodiment of the disclosure.

FIG. 2B depicts an exemplary pop-up alert window in a browser of a mobile terminal, with notices to a user that there would be a risk in executing the corresponding operation by the execution module of the mobile terminal, as described in FIG. 2A.

FIG. 3 depicts an exemplary framework diagram for a browser as depicted in FIG. 2A, according to an embodiment of the disclosure.

FIG. 4 is an exemplary flowchart illustrating a method performed by a server for monitoring and protecting a browser from malicious websites, according to another embodiment of the disclosure.

FIG. 5 depicts an exemplary framework diagram for a server, which protects a browser from malicious websites, according to an embodiment of the disclosure.

FIG. 6 depicts an exemplary framework diagram for a monitoring system which carries out the method for monitoring and protecting a browser from malicious websites, according to an embodiment of the disclosure.

### DETAILED DESCRIPTION OF THE EMBODIMENTS

The various embodiments of the present disclosure are further described in details in combination with attached drawings and embodiments below. It should be understood that the specific embodiments described here are used only to explain the present disclosure, and are not used to limit the present disclosure. In addition, for the sake of keeping description brief and concise, the newly added features, or features that are different from those previously described in each new embodiment will be described in details. Similar features may be referenced back to the prior descriptions in a prior numbered drawing or referenced ahead to a higher numbered drawing.

In order to clarify the object, technical scheme and advantages of the present disclosure more specifically, the present disclosure is illustrated in further details with the accompanied drawings and embodiments. It should be understood that the embodiments described herein are merely examples to illustrate the present disclosure, not to limit the present disclosure.

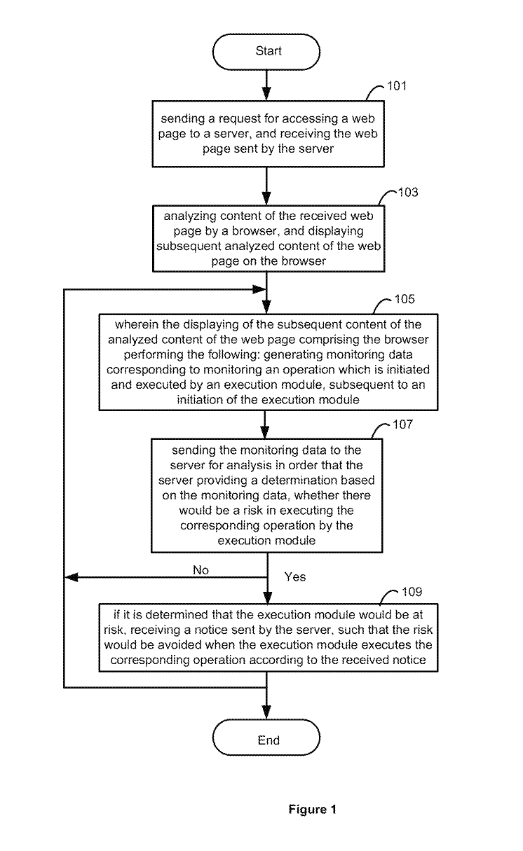

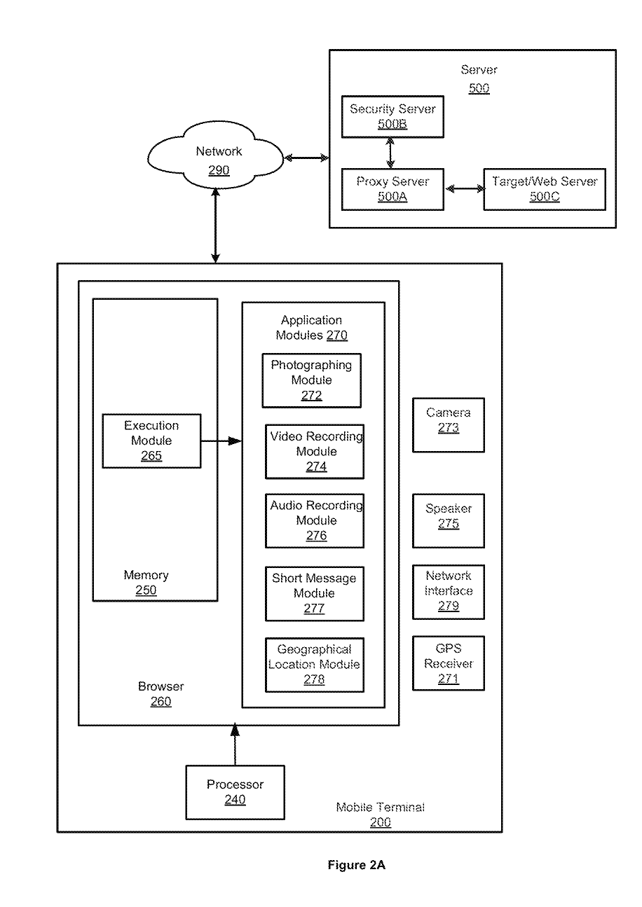

FIG. 1 is an exemplary flowchart illustrating a method for monitoring and protecting a browser of a mobile terminal (such as mobile terminal (200) in FIG. 2A) from malicious websites, according to an embodiment of the disclosure. In addition, FIGS. 2A and 2B are referenced to in order to facilitate detail description of FIG. 1.

The method may include at least the following exemplary steps:

Step 101: a browser (e.g., browser (260) in FIG. 2) on the client side sending a request for accessing a web page to a server (e.g., server (500) in FIG. 2A) through a network (290), and the browser (260) may receive the web page corresponding to the request which is sent by the server (500),

In an embodiment, the server (500) may be a proxy server (500A) or a target/web server (500C). The proxy server (500A) may be a server which facilitates accessing a web page for a user according to user's request. The target/web server (500C) may be a server which stores and host the web page as requested by the user, and the target/web server may directly provide the web page to the browser (260) on the mobile terminal (200), as requested by the user.

Step 103: analyzing content of the received web page by the browser (260) on the client side and displaying on the browser subsequent analyzed content of the web page. The browser may need to analyze the received web page content first, and then load and display the analyzed web page content.

Step 105: the displaying of the subsequent content of the analyzed content of the web page may include the browser (260) performing the following: generating monitoring data corresponding to monitoring an operation which is initiated and executed by an execution module (e.g., execution module (265) in FIG. 2A), subsequent to an initiation of the execution module (265).

The browser (260) includes at least an execution module (265), which may be initiated under the control of a web page being displayed. When the execution module (265) is initiated, the execution module may automatically control and operate the various application modules (272-278) in the application module (270). The application module (270) may include a photographing module (272), a video recording module (274), an audio recording module (276), a short message module (277), a geographical location module (278), a network module and an address book module (not shown).

The execution module (265) may control and operate the photographing module (272) and the video recording module (276) by turning on and off the camera (273) to snap pictures or video of surrounding scenery through the camera (273). The execution module (265) may turn on or off the audio recording module to record conversation or sound of the surrounding through the speaker (275). The execution module (265) may open or read the received short messages network interface (279) to gain access on-line to send or. The execution module may turn on or off a GPS receiver (271) to determine a current geographical location of the mobile terminal (200).

The monitoring of the data may include data monitoring from one or more of: operation types to be executed by the execution module, number of times of the corresponding operations being executed, or monitoring content of the operation.

The types of corresponding operations refer to the various operations performed by the application module (270), such as the photographing module (272), the video recording module (274), the audio recording module (276), the short message module (277) and the geographical location module (278) on the mobile terminal (200).

In another embodiment, the monitoring data may be real time data collected as a result of an initial analysis of the data collected from the above corresponding operations after the browser (260) receiving the requested web page from the server (500). The initial analysis may be making a determination by the browser (260) whether the monitoring data may cause a risk to the execution module (265).

More specifically, the initial analysis of the monitoring data may include comparing the monitoring data with pre-stored risk data, and if the monitoring data match the pre-stored risk data, the operation as executed by the execution module (265) to which the monitoring data correspond is determined to cause a risk. If the monitoring data do not match the pre-stored risk data, the operation as executed by the execution module to which the monitoring data correspond is determined to cause no risk.

The pre-stored risk data may include such scenarios as the number of times of the corresponding operations being executed by the execution module (265) exceeds a preset threshold value, or the execution module (265) sending short messages to the addresses that open malicious charging. Some examples in which the number of operations as executed may exceed the preset value may be the number of times that the execution module (265) controls and turns on the camera head in the photographing module (272) to exceed 5 times, or that the number of times the execution module (265) controls and moves a mouse device on the mobile terminal (200) to exceed 3 times, etc,

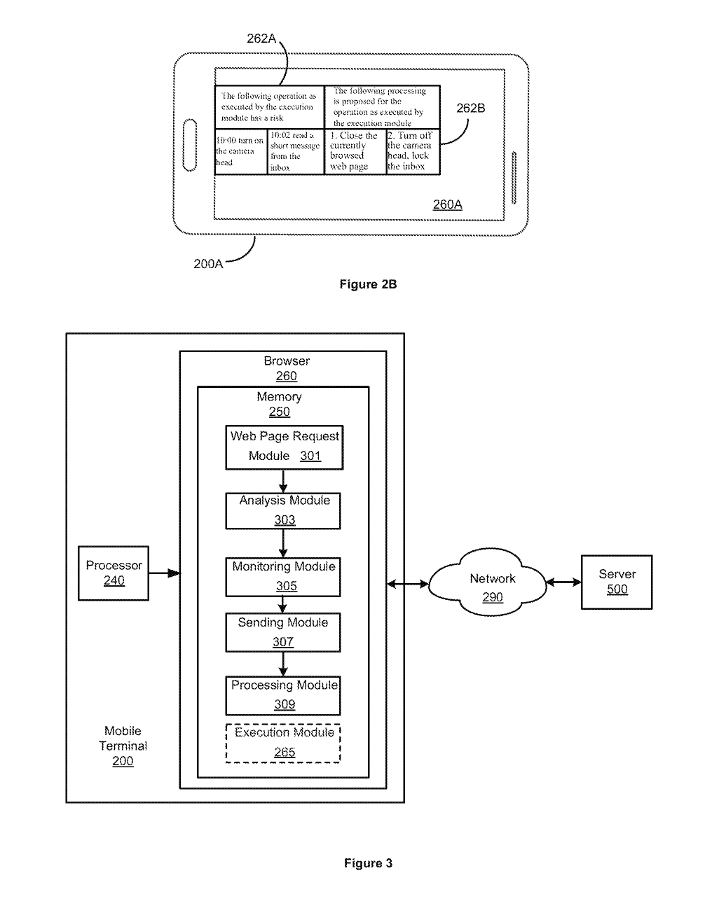

In an embodiment of the present disclosure, when monitoring the operation as executed by the execution module (265) of the browser (260), the following method may be used for monitoring: a notification module may be set up in the execution module (265) of the existing browser (260), this notification module may automatically acquire the operation as executed by the execution module (265) of the browser, and notify the monitoring module (e.g., monitoring module (305) as shown in FIG. 3) of the operation as executed by the execution module (265) of the browser (260).

Naturally, in an embodiment of the present disclosure as shown in FIG. 3, the monitoring module (305) may also be embedded in the execution module (265) of the browser (260), After the execution module (265) of the browser (260) is initiated, the monitoring module (305) may monitor the operation as executed by the execution module (265), and generate the monitoring data. Alternately, in another embodiment, the monitoring module (305) may provide notification mechanism while monitoring the operation as executed by the execution module (265) of the browser (260) as mentioned above.

Step 107: sending the monitoring data to the server (500) for analysis in order that the server (500) providing a determination based on the monitoring data, whether there would be a risk in executing the corresponding operation by the execution module (265). If it is determined that the execution module (265) would be at risk, proceed to step (109), otherwise, return to step (105).

In an embodiment, the server (500) may include a security server (500B) dedicated for analysis of monitoring data received from the mobile terminal (200). In another embodiment, the function of the security server (500B) may be included in the target/web server (500C) which not only provides the requested web pages to the client side, but may also analyze the received monitoring data. With regard to the time selection for sending the monitoring data to the server 9500), the browser (260) may avoid a normal network visit time period of the user (for example, the time period in which a large number of client side users request web page browsing from the server (500)) so as to reduce impact to user experience.

When the browser (260) sends monitoring data to the server (500), the browser (260) may encrypt and send the monitoring data to the server (500) for maximal security enhancement. For example, the communication protocol at the time of sending may be a secure socket layer protocol. The secure socket layer (SSL) protocol is a technology for the sender and the receiver to communicate through a security connection. Within this security connection, all the data maybe encrypted before being sent, while the other party may decrypt the data at the time of receiving and before the data may be processed, so that privacy of communication may be guaranteed.

The encryption algorithm may utilize an existing asymmetric key encryption algorithm or a symmetric key encryption algorithm, etc., and the encryption algorithm may be dynamically updated.

The data volume of monitoring data sent by the browser (260) to the server (500) may be adaptively set up in accordance with the type of network used by the client side user. If the client side goes online via Wi-Fi (wireless fidelity), the browser (260) may send a greater volume of data so as to increase the efficiency of the server (500) when analyzing the monitoring data. This is because currently it is cheaper relatively for the client side to use

Wi-Fi to go online, and the cost for uploading data is relatively lower. If the client side goes online via GPRS (General Packet Radio Service technology), the browser (265) may send a lower volume of data.

For example, the browser (265) may only send relatively sensitive monitoring data, and the relatively sensitive monitoring data may be determined in advance based on actual need. This is mainly because currently it is more expensive relatively for the client side to use GPRS to go online, and the cost for uploading data is relatively higher as well. The relatively sensitive monitoring data may be the monitoring data to show that the operation as executed by the execution module (265) has a risk.

Furthermore, the browser (265) may compress to the maximum degree the monitoring data prior to sending to the server (500) in order to save on user flow volume and reduce interference with the normal use of the network (290) by the user, With regard to the compression method, a method as stipulated with the server (500) may be used for making data compression. For example, it may be stipulated that numbers, etc. may used to represent the different types, etc. of operations, and with regard to the number of operations and the content of operation, etc., the monitoring data may be further compressed using various types of known compression algorithms.

Step 109: if it is determined that the execution module (265) would be at risk, receiving one or more notice (e.g., see notice (262) in FIG. 2B) sent by the server (500), such that the risk would be avoided when the execution module (265) executes the operation corresponding to the received notice (such as notice (262A) and notice recommendation (262B) as shown in FIG. 2B).

The received notice (262A, 262B) may include one or both of an alert notice (262A) and a recommendation notice (262B). For example, the received notice (262A, 262B) may notify, by way of a pop-up alert notice (262A) window in the browser (see browser (260A) in FIG. 2B) to the user that the operation as executed by the execution module (265) may have a risk. With the pop-up alert notice (262A) window notifying the user that the operation as executed by the execution module (265) may be at risk, it may enable the user to take timely measures to leave the risk web page being currently browsed, according to the one or more notice recommendation (262B) (such as the notice's recommendation (262B) as shown in FIG. 2B).

In an embodiment, the receiving of the one or more notice (262A, 262B) may include a message of an interception of a potentially malicious operation if executed by the execution module (265). The interception of the potentially malicious operation may cause the execution module (265) to jump from the currently displayed web page content (which may contain malicious codes) to another web page content (i.e., web page which is secured and contains no malicious codes) for displaying, banning altogether the potentially malicious operation from execution by the execution module, display one or more notice recommendation (262B) to warn the user to take one or more further actions, such as closing the currently browsed web page, turning off the camera or locking the inbox, to name a few.

In brief, the above disclosed method enable the browser (260) to intercept in real time, a potentially malicious web page before it is executed by the execution module (265), so that the execution module (265) may carry out preventive operations according to the received notice (262A, 262B) from the server (500) to prevent loss of privacy, loss of sensitive information or incurring financial damages as a result of such loss of privacy or sensitive information as a result of carrying out operations caused by visiting a malicious web page by the user.

In addition, the present embodiment discloses compressing and encrypting the monitoring data and then sending the monitoring data to the server (500). Such practice may guarantee that the monitoring data be quickly and securely transmitted to the server (500) for analysis.

FIG. 3 depicts an exemplary framework diagram for a browser (260) for monitoring and protection from malicious websites, as depicted in FIG. 2A, according to an embodiment of the disclosure. As shown, the browser (260) include at least a memory (250) which stores instruction codes operable as plurality of modules (301-309) operating in conjunction with at least a processor (240), wherein the plurality of modules include:

A web page request module (301), which sends a request for accessing a web page to a server (500), and receives the web page sent by the server (500);

An analyzing module (303) which analyzes content of the received web page according to the request, and displays subsequent analyzed content of the web page on the browser (260),

A monitoring module (305), which generates monitoring data corresponding to monitoring an operation executed by an execution module (265), subsequent to an initiation of the execution module (265). The monitoring of the data may include monitoring one or more of: operation types to be executed by the execution module, number of limes of the corresponding operations being executed, or content of the operation.

A sending module (265), which sends the monitoring data to the server (500) for analysis in order that the server (500) provides a determination based on the monitoring data, that whether the execution module (265) would be at risk in executing the corresponding operation. In another embodiment, the sending module (307) compresses and encrypts the monitoring data prior to sending the monitoring data to the server (500).

If it is determined that the execution module (265) would be at risk, a processing module (309) receives and processes one or more notice (262A, 262B) sent by the server (500), such that the risk would be avoided when the execution module (265) executes the corresponding operation according to the processed received notice (262A, 262B). The executing of the corresponding operation by the execution module may include: hopping from content displayed by a current web page to content displayed by another web page, or preventing the execution of the corresponding operation by the execution module.

Preferably, the processing module (309) proceeds to the steps for monitoring the operation as executed by the execution module (265) of the browser (260), and generating the monitoring data, if there is no risk.

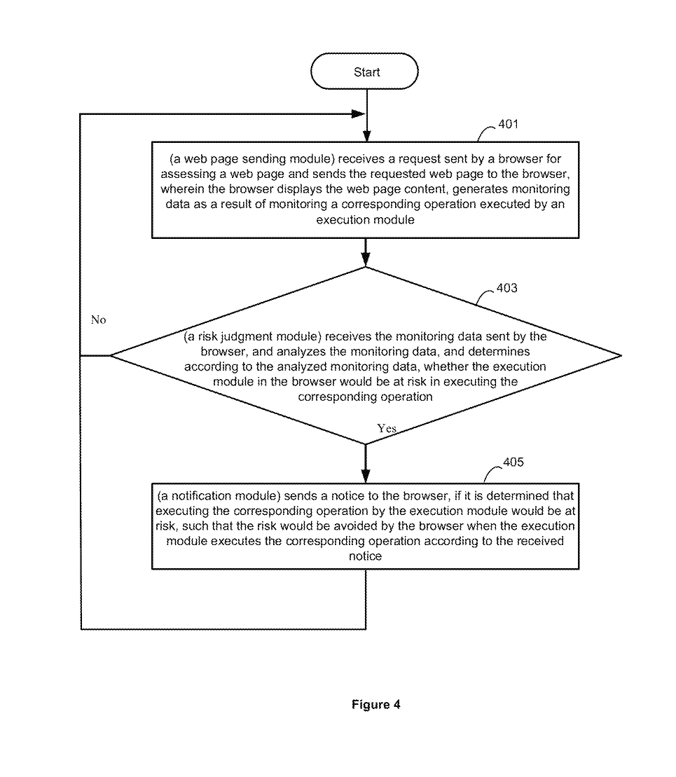

FIG. 4 is an exemplary flowchart illustrating a method performed by a server (500) for monitoring and protecting a browser (260) from malicious websites, according to another embodiment of the disclosure. The server (500) may include the following modules performing the following steps:

Step 401: a web page sending module (501), which receives a request sent by a browser (260) for accessing a web page and sends the requested web page to the browser, wherein the browser (260) displays the web page content, generates monitoring data as a result of monitoring a corresponding operation executed by an execution module (265).

Step 403: a risk judgment module (503), which receives the monitoring data sent by the browser, and analyzes the monitoring data, and determines according to the analyzed

monitoring data, whether the execution module (265) in the browser would be at risk in executing the corresponding operation. If there is a risk, proceeds to step 405, otherwise, proceeds to repeat step 403 again.

The following method may be used when making a determination on whether or not the operation corresponding to the monitoring data as executed by the execution module (265 has a risk, by the risk judgment module compares the monitoring data with pre-stored risk data, and: if the monitoring data matches the pre-stored risk data, it is then determined that executing the corresponding operation by the execution module would be at risk; if the monitoring data do not match the pre-stored risk data, it is then determined that executing the corresponding operation by the execution module would not be at risk.

The pre-stored risk data may include such scenarios as the number of operations as executed by the execution module (265) may exceed a preset value and the execution module (265) sending short messages to the addresses that causes open malicious charging. Some examples in which the number of operations as executed exceeding the preset value may be that the number of times by which the execution module (265) controlling and turning on the camera (273) in the photographing module (272) to exceed 5 times, or that the number of times by which the execution module (265) controlling and moving the mouse on the mobile terminal (200) to exceed 3 times, etc.

Step 405: if the operation corresponding to the monitoring data as executed by the execution module (265) may be a risk operation, a notification module (505) may send one or more notice (262A, 262B) to the browser (260), such that the risk would be avoided by the browser when the execution module executes the corresponding operation according to the received notice (262A, 262B).

Afterwards, step 401 may be repeated to start another checking cycle.

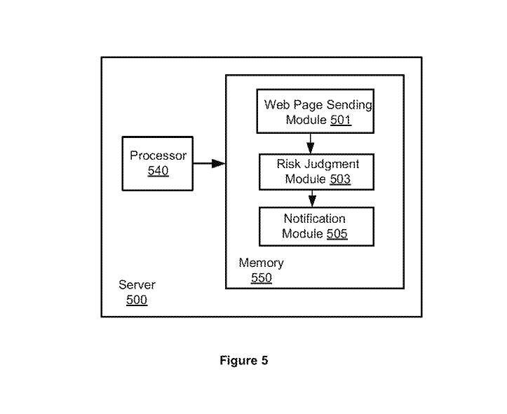

FIG. 5 depicts an exemplary framework diagram for a server (500), which protects a browser (260) from malicious websites, according to an embodiment of the disclosure. The server (500) may include at least a processor (540) operating in conjunction with at least a memory (550) which stores instruction codes operable as plurality of modules (501-505), wherein the plurality of modules may include at least: a web page sending module (501), a

risk judgment module (503) and a notification module (505). The details of the functions carried out by the above described modules (501-505) have already been described in the flow chart of FIG. 4, and will not be repeated again.

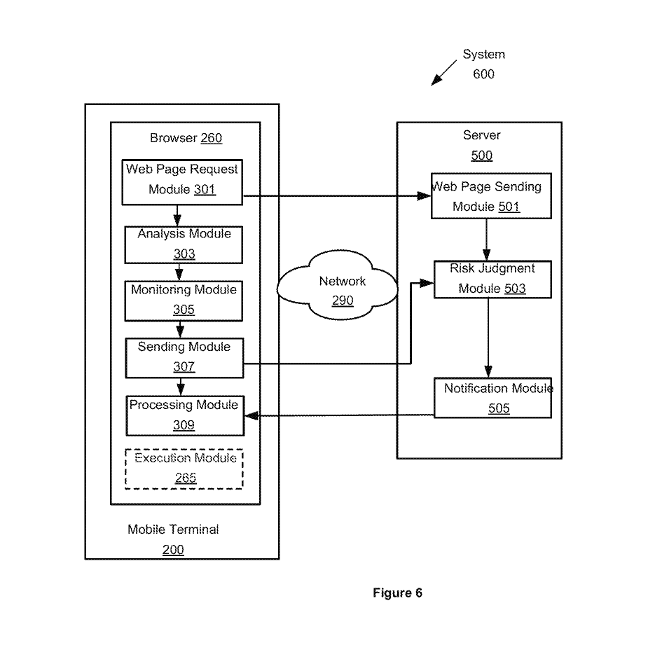

FIG. 6 depicts an exemplary framework diagram for a monitoring system (600) which carries out the method for monitoring and protecting a browser (260) from malicious websites, according to an embodiment of the disclosure. For simplification, only the relevant portions of the browser (260) and the server (500) may be shown. Some missing reference designations may be referred back to FIGS. 3 and 5.

The monitoring system (600) may include at least: a browser (260) of a mobile terminal (200) communicating to a server (500) through a network (290), wherein: the browser may include at least a first memory (250) which stores instruction codes operable as first plurality of modules (265, 301-309) operating in conjunction with at least a first processor (240), wherein the first plurality of modules (265, 301-309) may include: a web page request module (301), an analysis module (303), a monitoring module (305), and a sending module (307), a processing module and an execution module (265).

The server (500) may include at least a second processor (540) operating in conjunction with at least a second memory (550) which stores instruction codes operable as second plurality of modules (501-505), wherein the second plurality of modules (501-505) may include: a web page sending module (501), a risk judgment module (503), and a notification module (505).

The web page request module (301) of the browser (260) may send a request for accessing a web page to a server (500), and receives the web page sent by the server (500). The web page sending module (307) of the server (500) may receive the request sent by the browser for accessing the web page and sends the requested web page to the browser (260).

An analysis module (303) of the browser (260) may analyze content of the received web page by a browser, and displays subsequent analyzed content of the web page on the browser (260).

The monitoring module (307) of the browser may generate monitoring data corresponding to monitoring an operation executed by an execution module (265), subsequent to an initiation of the execution module;

The sending module (307) of the browser sends the monitoring data to the server (500) for analysis. In addition, the sending module (307) of the browser (260) may compress and encrypt the monitoring data prior to sending the monitoring data to the server (500).

The risk judgment module (303) of the server (500) may receive the monitoring data sent by the browser (260), and analyzes the monitoring data, and determines according to the analyzed monitoring data, whether the execution module (265) in the browser (260) would be at risk in executing the corresponding operation.

In addition, the risk judgment module (503) of the server (500) may compare the monitoring data with pre-stored risk data, and: if the monitoring data matches the pre-stored risk data, it is then determined that executing the corresponding operation by the execution module (265) would be at risk. Otherwise, if the monitoring data do not match the pre-stored risk data, it is then determined that executing the corresponding operation by the execution module (265) would not be at risk.

If it is determined that executing the corresponding operation by the execution module (265) would be at risk: the notification module (505) of the server (500) may send one or more notice to the browser, and the processing module (309) of the browser receives and processes the one or more notice, such that the risk would be avoided when the execution module (265) executes the corresponding operation according to the processed received notice (262A, 262B).

Preferably, the processing module (309) may proceed to the steps for monitoring the operation as executed by the execution module (265) of the browser in the monitoring module, and generating the monitoring data, if there is no risk.

The above disclosed embodiments provide at least the following technical benefits, namely: the browser (260) of a mobile terminal (200) may initiate the execution module (265) to monitor an operation of the browser, and generates monitoring data which are sent to a server (500). The server (500) analyzes the received monitoring data, so as to make a judgment or determination on whether or not the browser's execution module would be put at risk when the operation corresponding to the monitoring data is being executed by the browser's execution module (265).

If it is determined that the execution of the operation would put the browser's execution module (265) at risk, the server may send to the browser (of the mobile terminal) one or more notice information (which may carry instructions on how to safely handle the operation) so that a processing module (309) of the browser may process the one or more notice (262A, 262B) such that the risk would be avoided when the execution module (265) executes the corresponding operation according to the processed received notice. In brief, the present disclosure enables real time detection of a risk and neutralizes the risk (through the one or more notice information) before during web page browsing, unlike the current situation which would be too late to take any corrective action to avoid the risk,

It should be understood by those with ordinary skill in the art that all or some of the steps of the foregoing embodiments may be implemented by hardware, or software program codes stored on a non-transitory computer-readable storage medium with computer-executable commands stored within. For example, the disclosure may be implemented as an algorithm as codes stored in a program module or a system with multi-program-modules. The computer-readable storage medium may be, for example, nonvolatile memory such as compact disc, hard drive, ROM or flash memory. The computer-executable commands are used to enable a computer, server, a smart phone, a tablet or any similar computing device to render monitoring and protecting a browser from malicious websites.

The foregoing represents only some preferred embodiments of the present disclosure and their disclosure cannot be construed to limit the present disclosure in any way. Those of ordinary skill in the art will recognize that equivalent embodiments may be created via slight alterations and modifications using the technical content disclosed above without departing from the scope of the technical solution of the present disclosure, and such summary alterations, equivalent has changed and modifications of the foregoing embodiments are to be viewed as being within the scope of the technical solution of the present disclosure.

1. A method for monitoring and protecting a browser from malicious websites, the method comprising:
sending a request for accessing a web page to a server, and receiving the web page sent by the server;
analyzing content of the received web page by a browser, and displaying on the browser subsequent analyzed content of the web page, wherein the displaying of the subsequent content of the analyzed content of the web page comprising the browser performing the following:
generating monitoring data corresponding to monitoring an operation which is initiated and executed by an execution module, subsequent to an initiation of the execution module; and
sending the monitoring data to the server for analysis in order that the server providing a determination based on the monitoring data, whether there would be a risk in executing the corresponding operation by the execution module;
if it is determined that the execution module would be at risk, receiving one or more notice sent by the server.

2. The method according to claim 1, wherein the sending of the monitoring data to the server for analysis and the providing of the determination that whether there would be the risk in executing the corresponding operation by the execution module, comprising:
if it is determined that there would be no risk, proceeds to executing the corresponding operation by the execution module, and continue with the generating of the monitoring data.

3. The method according to claim 1, wherein the sending of the monitoring data to the server for analysis, comprising:
compressing and encrypting the monitoring data prior to sending the monitoring data to the server.

4. The method according to claim 1, wherein the monitoring of the data comprising data monitoring one or more of: operation types to be executed by the execution module, number of times of the corresponding operations being executed, or content of the operation.

5. The method according to claim 1, wherein the executing of the corresponding operation by the execution module, comprising: hopping from content displayed by a current web page to content displayed by another web page, or preventing the execution of the corresponding operation by the execution module.

6. A browser for monitoring and protection from malicious websites, comprises at least a memory which stores instruction codes operable as plurality of modules operating in conjunction with at least a processor, wherein the plurality of modules comprise:
a web page request module, which sends a request for accessing a web page to a server, and receives the web page sent by the server;
an analyzing module which analyzes content of the received web page according to the request, and displays subsequent analyzed content of the web page on the browser,
a monitoring module, which generates monitoring data corresponding to monitoring an operation executed by an execution module, subsequent to an initiation of the execution module; and
a sending module, which sends the monitoring data to the server for analysis in order that the server provides a determination based on the monitoring data, that whether the execution module would be at risk in executing the corresponding operation;
if it is determined that the execution module would be at risk, a processing module which receives and processes one or more notice sent by the server.

7. The browser according to claim 6, wherein if it is determined that there would be no risk, the execution module proceeds to executes the corresponding operation, and the monitoring module continues to generate the monitoring data.

8. The browser according to claim 6, wherein the sending module compresses and encrypts the monitoring data prior to sending the monitoring data to the server.

9. The browser according to claim 6, wherein the monitoring of the data comprising data monitoring one or more of: operation types to be executed by the execution module, number of times of the corresponding operations being executed, or content of the operation.

10. The browser according to claim 6, wherein the executing of the corresponding operation by the execution module, comprising: hopping from content displayed by a current web page to content displayed by another web page, or preventing the execution of the corresponding operation by the execution module.

11. A browser monitoring method, comprising:
receiving a request sent by a browser for accessing a web page;
sending the requested web page to the browser, wherein the browser displays the web page content, generates monitoring data as a result of monitoring a corresponding operation executed by an execution module;
receiving the monitoring data sent by the browser, and analyzing the monitoring data,
determining according to the analyzing of the monitoring data, whether the execution module in the browser would be at risk in executing the corresponding operation;
if it is determined that the execution module would be at risk, sending one or more notice to the browser.

12. The monitoring method according to claim 11, wherein after receiving the monitoring data sent by the browser and analyzing the monitoring data, and determining whether there would be a risk in the browser in executing the corresponding operation by the execution module, comprising:
if it is determined that there would be no risk, sending the one or more notice to the browser, such that the browser proceeds to executing the corresponding operation by the execution module, and
continuing receiving generated monitoring data from the browser.

13. The monitoring method according to claim 11, wherein the determining of the received monitoring data that whether there would be a risk in the browser in executing the corresponding operation by the execution module, comprising
comparing the monitoring data with pre-stored risk data, and:
if the monitoring data matches the pre-stored risk data, it is then determined that executing the corresponding operation by the execution module would be at risk;
if the monitoring data do not match the pre-stored risk data, it is then determined that executing the corresponding operation by the execution module would not be at risk.

14. A server for monitoring and protecting a browser from malicious websites, comprises at least a processor operating in conjunction with at least a memory which stores instruction codes operable as plurality of modules, wherein the plurality of modules comprise:
a web page sending module, which receives a request sent by a browser for accessing a web page and sends the requested web page to the browser, wherein the browser displays the web page content, generates monitoring data as a result of monitoring a corresponding operation executed by an execution module;
a risk judgment module, which:
receives the monitoring data sent by the browser, and analyzes the monitoring data, and
determines according to the analyzed monitoring data, whether the execution module in the browser would be at risk in executing the corresponding operation;
a notification module, which sends one or more notice to the browser, if it is determined that executing the corresponding operation by the execution module would be at risk.

15. The server according to claim 14, wherein the notification module sends one or more notice to the browser, if the risk judgment module has determined that executing the corresponding operation by the execution module would not be at risk, such that the browser proceeds to executing the corresponding operation by the execution module, and the server continues receiving the generated monitoring data from the browser.

16. The server according to claim 14, wherein the risk judgment module compares the monitoring data with pre-stored risk data, and:
if the monitoring data matches the pre-stored risk data, it is then determined that executing the corresponding operation by the execution module would be at risk;
if the monitoring data do not match the pre-stored risk data, it is then determined that executing the corresponding operation by the execution module would not be at risk.

17. A monitoring system, comprises: a browser communicating to a server through a network, wherein:
the browser comprises at least a first processor operating in conjunction with at least a first memory which stores instruction codes operable as first plurality of modules, wherein the first plurality of modules comprise: a web page request module, a analyzer module, a monitoring module, and a sending module;
the server comprises at least a second processor operating in conjunction with at least a second memory which stores instruction codes operable as second plurality of modules, wherein the second plurality of modules comprise: a web page sending module, a risk judgment module, and a notification module;
wherein:
the web page request module of the browser sends a request for accessing a web page to a server, and receives the web page sent by the server;
the web page sending module of the server receives the request sent by the browser for accessing the web page and sends the requested web page to the browser;
the analyzing module of the browser analyzes content of the received web page by a browser, and displays subsequent analyzed content of the web page on the browser;
the monitoring module of the browser generates monitoring data corresponding to monitoring an operation executed by an execution module, subsequent to an initiation of the execution module;
the sending module of the browser sends the monitoring data to the server for analysis;
the risk judgment module of the server receives the monitoring data sent by the browser, and analyzes the monitoring data, and determines according to the analyzed monitoring data, whether the execution module in the browser would be at risk in executing the corresponding operation;
if it is determined that executing the corresponding operation by the execution module would be at risk: the notification module of the server sends one or more notice to the browser, and the processing module of the browser receives and processes the one or more notice.

18. The monitoring system of claim 17, wherein the risk judgment module of the server compares the monitoring data with pre-stored risk data, and:
if the monitoring data matches the pre-stored risk data, it is then determined that executing the corresponding operation by the execution module would be at risk;
if the monitoring data do not match the pre-stored risk data, it is then determined that executing the corresponding operation by the execution module would not be at risk.

19. The monitoring system of claim 17, wherein the sending module of the browser compresses and encrypts the monitoring data prior to sending the monitoring data to the server.

20. A non-transitory computer-readable medium having stored thereon, a computer program having at least one code section being executable by a mobile terminal which causes the mobile terminal to perform steps for monitoring and protecting a browser from malicious websites, comprising:
sending a request for accessing a web page to a server, and receiving the web page sent by the server;
analyzing content of the received web page by a browser, and displaying on the browser subsequent analyzed content of the web page, wherein the displaying of the subsequent content of the analyzed content of the web page comprising the browser performing the following:
generating monitoring data corresponding to monitoring an operation which is initiated and executed by an execution module, subsequent to an initiation of the execution module; and
sending the monitoring data to the server for analysis in order that the server providing a determination based on the monitoring data, whether there would be a risk in executing the corresponding operation by the execution module;
if it is determined that the execution module would be at risk, receiving one or more notice sent by the server.

21. The non-transitory computer-readable medium according to claim 20, wherein the sending of the monitoring data to the server for analysis and the providing of the determination that whether there would be the risk in executing the corresponding operation by the execution module, comprising:
if it is determined that there would be no risk, proceeds to executing the corresponding operation by the execution module, and continue with the generating of the monitoring data.

22. The non-transitory computer-readable medium according to claim 20, wherein the sending of the monitoring data to the server for analysis, comprising:
compressing and encrypting the monitoring data prior to sending the monitoring data to the server.

23. The non-transitory computer-readable medium according to claim 20, wherein the monitoring of the data comprising data monitoring one or more of: operation types to be executed by the execution module, number of times of the corresponding operations being executed, or content of the operation.

24. The non-transitory computer-readable medium according to claim 20, wherein the executing of the corresponding operation by the execution module, comprising: hopping from content displayed by a current web page to content displayed by another web page, or preventing the execution of the corresponding operation by the execution module.
